(19) United States
(12) Patent Application Publication
(10) Pub. No.: US 2013/0307992 A1
(43) Pub. Date: Nov. 21, 2013

(54) METHOD FOR MANAGING IR IMAGE DATA

(71) Applicant: FLIR Systems AB, Taby (SE)

(72) Inventors: Mikael Erlandsson, Uppsala (SE); Erland George-Svahn, Solna (SE); Torsten Sandbäck, Stockholm (SE)

(73) Assignee: FLIR Systems AB, Taby (SE)

(21) Appl. No.: 13/952,566

(22) Filed: Jul. 26, 2013

Related U.S. Application Data
(63) Continuation-in-part of application No. PCT/EP2012/051385, filed on Jan. 27, 2012.
(60) Provisional application No. 61/437,282, filed on Jan. 28, 2011.

(51) Int. Cl. H04N 5/33

(52) U.S. Cl. CPC H04N 5/332
USPC 348/164

(57) ABSTRACT

This disclosure relates in general to the field of visualizing, imaging and animating groups of images, and annotations in IR-cameras. Various techniques are provided for a method of managing IR image data on a group level. For example, the method may comprise; capturing an IR image comprising temperature data representing the temperature variance of an object scene; storing the IR image as a first data item in a predetermined data structure; storing a second data item in said predetermined data structure; and associating in said data structure the first and the second data item such that an operation is enabled on the first and the second associated data items jointly as a group of data items.

### CROSS-REFERENCE TO RELATED APPLICATIONS

This application is a continuation-in-part of International Patent Application No. PCT/EP2012/051385 filed Jan. 27, 2012 and entitled “A METHOD FOR MANAGING IR IMAGE DATA”, which is incorporated herein by reference in its entirety.

International Patent Application No. PCT/EP2012/051385 claims the benefit of U.S. Provisional Patent Application No. 61/437,282 filed Jan. 28, 2011, which is hereby incorporated by reference in its entirety.

### TECHNICAL FIELD

This invention relates in general to the field of visualizing, imaging and animating groups of images and annotations in IR-cameras.

### BACKGROUND

### General Background

During the last years, mobile technology and generally hand held devices have been evolving rapidly both in terms of hardware technology and in terms of the usability and flexibility of the UI (User Interface) used. There are several examples of hand held devices that became famous during the last years and were so widely accepted by users that they redefined several features in the HCl (Human Computer Interaction) field and affected the evolution of UIs. The latest trends concerning those types of devices involve the growing integration of graphical effects and animation techniques in the UI, which combined with direct manipulation techniques, enrich the user experience. By the use of such techniques, functionalities that were considered confusing and troublesome are described and presented to the users in a meaningful way, allowing in the same time the evolution of more and more elaborate and specialized applications. Multimodal interaction, such as haptics, touch and other kind of interactivity had facilitated the use of new devices as well. Similar evolutionary steps were made in the field of IR (Infrared) cameras cameras that can visualize heat, for example temperature distributions in a depicted scene, into images. Moving from a form of almost fixed, not easily movable devices to hand held devices, their use became broader and various products were designed to address different user needs.

IR cameras today are used for a variety of applications for example building diagnostics, medical purposes, electrical and mechanical industries, defense systems, etc. Therefore, they address a wide scope of users with different needs and from different educational and cultural backgrounds. Just like mobile devices, the UI of IR cameras is not directed to one type of users, but instead it should be as inclusive and general as possible, focusing on usability and aiding the users' understanding. Based on those facts, one can argue that the techniques used for the design of UIs of other hand held devices, can be also beneficial for the case of hand held IR cameras. Graphic effects, animation techniques and direct manipulation can not only enrich the user experience in terms of IR technology, but also ease their understanding.

### Specific Background

There is a need of integrating, in a meaningful way, state of the art interaction techniques in the UI of IR cameras. Infrared thermography aims to describe a very abstract context—IR cameras visualize representation of temperatures. IR cameras are known for being able to identify the amount of radiation emitted by objects within a specific set of temperatures. The images acquired are called thermograms and they represent emissions which do not concern the visible light wavelength, but instead a part of the electromagnetic spectrum that humans understand as heat. One of the most known problems of thermography is that objects not only emit their own energy, but they also reflect infrared energy of other sources as well. This can lead to many problems of understanding and also to inaccurate measurements.

When people use IR cameras for the first time it is usually quite difficult for them to understand the context of the image they are watching. Users usually have problems of navigation to space and identification of the objects contained in the pictures. The lack of real visual data, in comparison to common digital cameras, frustrates the user and reduces the correct perception of space and objects. Unfortunately, this is not the case only for new users; experienced users as well deal with similar problems that affect the accuracy of the data they acquire and the creation of correct IR images for the problems detected.

Based on all those facts, there is a need to help the users of IR cameras to understand and easily use a continuously alternating visualization for an abstract context, such as temperatures.

Combining multiple data sources (e.g., video, still images, digital images) in an IR-camera a user-friendly way is not a simple problem to solve. There is a need for an improved way to aid the users' understanding and efficiency in cases where the combination of various data is required (IR video data, IR image, digital image, documents, etc.).

### SUMMARY

Various techniques are disclosed for a method to manage IR image data on a group level, which gives the user an enhanced overview over the data connected to an IR image. Thus, methods according to various embodiments of the disclosure may achieve various advantageous effects including, for example:
Maintaining a better understanding for the users of what data they are looking at;
Simplifying for the user when managing several connected images and/or other data;
Spreading the use of IR cameras to a larger population of users by making the IR cameras more accessible and usable to such a level that would allow them to be used for further applications; and other beneficial effects.

In one embodiment of the present disclosure, a method of managing IR image data may include, in no specific order of performance: capturing an IR image comprising temperature data representing the temperature variance of an object scene; storing the IR image as a first data item in a predetermined data structure; storing a second data item in said predetermined data structure; and associating in said data structure the first and the second data item as a group of data items such that an operation is enabled on the first and the second associated data items jointly as a group of data items.

In one embodiment, said second data item for example is a selection of: a digital camera photo (visual image); a user defined text annotation; a voice annotation; a sketch; a fused IR image; or a filtered IR image.

In another embodiment, the said operation on said group of data items is a selection of: associating the group of data items to a common descriptor parameter (name); deleting the group of data items; copying the group of data items; adding the group of data items to a report; and transmitting the group of data items to a recipient via a predetermined communications channel, such as by email, wife, Bluetooth; and presenting (displaying) the group of data items in an associated manner.

In other embodiments, the change between the presentation of a first and a second data item within a group of data items comprises an animation of the transition, presenting in the animation a selection of intermediate and simultaneous presentations of the first and the second data items.

In one embodiment, said first and second data is captured simultaneously in time. In one embodiment, said first and second data is captured in the same geographic area.

In one embodiment, a method for managing thermal image or IR images and related application data includes: receiving, in a data processing unit, a (one or a plurality) thermal image or an IR image depicting (representing) a physical object (still image, motion image or mpeg4); receiving in a data processing unit, an application data item (logically) related to the physical object represented by the thermal image or an IR image and a thermography application for the thermal imaging; associating the thermal image or an IR image with the application data item by assigning a common association indicium to the thermal image or an IR image and the application data item; storing the thermal image or an IR image and the application data item in a data structure such that the association as a group of data items is preserved between the thermal image or an IR image and the application data item; presenting or visualizing the thermal image or an IR image and the application data item as a group of data items in a data item container representation; and enabling or performing an operation on the container representation, for example the select, multiselect, draganddrop, copy, collapsible group, transmission of grouped items to other units and also enabling numbering of the group or naming or algorithm naming of the group by the user.

### BRIEF DESCRIPTION OF THE FIGURES

FIG. 1 shows a visualized view of two stored groups of data in accordance with an embodiment of the present disclosure.

FIG. 2a-b show another visualized view of animations visualizing transitions between different parts of group data, in accordance with an embodiment of the present disclosure.

FIG. 3a-b show another visualized view of animations, in accordance with an embodiment of the present disclosure.

FIG. 4a-b show another visualized view of animations, in accordance with an embodiment of the present disclosure.

FIG. 5 shows an implementation scheme in accordance with an embodiment of the present disclosure.

FIG. 6 shows a schematic view of software architecture in accordance with an embodiment of the present disclosure.

FIG. 7 shows a common window view for prototypes created according to an embodiment of the present disclosure.

FIG. 8 shows a diagram, or schematic view, of the controls used according to embodiments of the present disclosure.

FIG. 9 shows an example of a project tree with controls and models in accordance with an embodiment of the present disclosure.

FIG. 10 shows a system overview in accordance with an embodiment of the present disclosure.

FIG. 11 shows bringing an image from the archive in accordance with an embodiment of the present disclosure.

FIG. 12 shows an IR camera comprising a user interface (UI), in accordance with an embodiment of the present disclosure.

FIG. 13 is a schematic view of a thermography system in accordance with an embodiment of the present disclosure.

FIG. 14 is a block diagram of a method in accordance with an embodiment of the present disclosure.

FIG. 15 is a block diagram of a method in accordance with an embodiment of the present disclosure.

Embodiments of the disclosure and their advantages are best understood by referring to the detailed description that follows.

### DETAILED DESCRIPTION

### Introduction

Applying new kinds of interactivity to IR cameras might help users facing the problems arising from the constantly changing character of IR data and might compensate to a small extent for the lack of real digital data in terms of physical navigation into space.

A further objective that could be reached with the method according to the invention is to allow for IR cameras to become more known and widely used by the public. Until today the high cost of the IR cameras is a decisive factor that affects the amount of users that decide to buy an IR camera. By making the user interface (UI) more usable and enhanced according to the invention, the use of IR cameras is expected to expand into new areas, where they could be proved useful in ways that were not considered until now.

Combining multiple data sources (video, still images, digital images) in a user-friendly way in an IR-camera is not a simple problem to solve. A problem area identified is how to aid the user's understanding and efficiency in cases where the combination of various data is required (IR video data, IR image, digital image, documents, etc.). There is a need for an improved way to aid the user's understanding and efficiency in cases where the combination of various data is required (IR video data, IR image, digital image, documents, etc.).

Each data entity created in the UI (IR video, IR image, digital image, second IR image) should be an independent, solid and easily distinguishable entity, manipulable by the use of animation techniques and also by enabling the user to manage groups of data in an efficient manner. In other words, the data items do not only have links associating them, but the grouped data items may be referred to and managed on a group level. The difference from managing linked data items is that for linked data items one of the data items is managed/manipulated/processed, where after the same management/manipulation/processing is performed on all data items associated with the first data item. For instance, if an image is erased the user may receive a question from the system on whether the user would like to erase all associated images. For the grouped data items according to the invention on the other hand, the user may relate to the group as an identity, and perform management/manipulation/processing operations according to any of the embodiments below on the group as a whole, for example by referring to the group by using for instance a unique group ID, label or name attached to the group. For example, a user may select to view and operate on a group of data items by for instance selecting the group from a list or by referring to its name and thereby retrieve the group for view in the UI. Thus, by enabling the user to manage the data items on a group level by performing an operation on the data items on a group level, the user obtains a greater understanding regarding what data items he/she is operating on.

According to an embodiment, the user is viewing and managing image data in a standard, or general purpose, application. In such an application, the user may be presented with and enabled to operate on/manipulate/manage/process a visual representation of an IR image, but may not be able to see or manipulate the underlying data, such as radiometric measurement data or other image associated data that has been captured/obtained and associated with the image in a group, according to embodiments of the invention, comprising data items. According to embodiments of the invention, the user is still enabled to manage the data on a group level, according to any of the embodiments below, even though only part of the data comprised in a group (e.g., a visual image representation) is presented to the user in the UI. In other words, if the user selects to for example erase the image shown in the UI, the entire group of data items to which the image belongs will be erased, without the user having to perform any further operations.

An advantage of embodiments presented herein is that the user may erase, include in a report or perform any other operation of choice on an entire group of data items by performing a single action.

A further advantage with grouping data items and managing data items on a group level according to embodiments of the invention is that there is no risk that data items associated with a group are left in the system if the group is erased, as may be the case with for example linked data items.

A further advantage with embodiments of the invention is that a user may relate to an entire group of associated data items by referring to its unique ID, label or name. According to embodiments the user may further interact with a graphical visualization of the group of associated data items.

A further advantage with embodiments of the invention is that associated data, that puts into context IR image data that is often hard to interpret on its own, may easily be retrieved and managed when the user is enabled to view and manage the image data on a group level. Thus, the user does not have to keep track of the data related to a specific image in order to view a visualization of it or manage it. Instead, the user may simply refer to the group ID, label or name, or select the relevant group from a list of groups displayed in the UI, in order to obtain all information related to a specific IR image representation, or several IR image representations comprised in a group. In the UI, the user may then manipulate the group data items in order to visualize the relevant data item or items in a view that gives the user the best understanding of what information is shown in IR image representation.

A group of data items may comprise more than one image representation, for example several image representations showing a scene/object/region of interest from different angles or directions.

In this text, an image or image representation may refer to an image comprising visible light image data, IR image data or a combination of visible light image data and IR image data. Combination of visible light image data and IR image data in an image may for example be obtained by overlaying, superimposition, blending or fusion of image data. In this text, an image comprising visible light image data may be referred to as a digital camera photo, visual image, visual image representation or a digital visual image.

By designing specific ways of behavior for each data entity as according to the invention, the user is able to control the UI better and expect the results of the actions performed.

The method according to embodiments of the invention enables the user in an effective way to denote relationships between groups of data with different forms, and also allows the user to easily navigate through such entities. The method of the invention concerns the navigation from one type of data to another and the combination of different still forms of data in a useful way and aid the user to follow the spatial and relative context between different data sources and ease the understanding of the IR image.

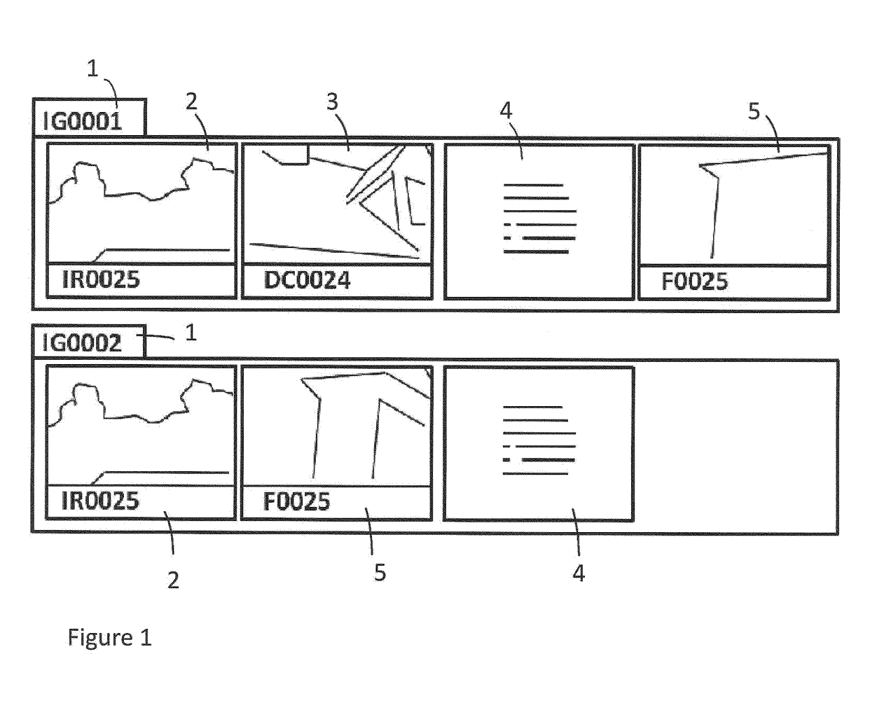

Multiple data items (e.g., IR-image, digital camera photo, user defined text annotation, voice annotation, sketch. etc.) are stored and visualized as a single group of data according to the method of the invention. The user can then apply actions to the group instead of managing single image one by one. For example, FIG. 1 shows a visualized view of a group of data according to an embodiment. Actions can for example be delete, copy, add to report or send to recipient by email, wifi, Bluetooth, etc., or simply to refer to the group by its group name.

FIG. 1 shows two examples of groups of different data items presented or visualized in a data item container representation according to the invention. One group of data items 1 is an example of a group with four different data items: an IR image 2, a digital visual image 3, text data 4 and a movie data file 5. The other group of data items 1 shown in FIG. 1 comprises three data items, an IR image 2, text data 4 and a movie data file 5. This example is not limiting the scope of the invention but is disclosed to illustrate the use of groups of data items according to the invention.

The grouping of data items enables the user to for example filter large amounts of data items. The grouping of data items also enables the user to name the group of data items and/or the related data item container representation using words or letters or numbers or combination of letters and numbers or algorithm naming.

The use of graphic effects and animation techniques according to the invention gives new ways of navigation inside a group of IR related data items. The method according to an embodiment uses the combination of different still forms or snapshots of data items in a useful way as explained below.

The invention aims to aid the user to follow the spatial and relative context between different data sources and ease the understanding of the IR image. As an example, the spatial context may be, but not limited to, several data items obtained at various spatial locations and all logically related to the same scene/object/region of interest. This might involve grouping, for example, an IR image, a visual image, text data or a movie data file related to the same scene/object/region of interest represented by a captured thermal or IR image. As yet an example this might involve grouping a data item such as captured IR image representing a scene/object/region of interest with a second IR image representing substantially the same scene/object/region of interest from a different angle or direction, a visual image representing substantially the same scene/object/region of interest, text data related to the scene/object/region of interest or movie data, such as visual or IR video recording, representing substantially the same scene/object/region of interest.

As another example, relative context may be, but is not limited to, an IR image, a visual image, text data or a movie data file relatively relating to substantially the same scene, object or region of interest used as a reference data item. As yet an example this might involve grouping a captured IR image representing a scene/object/region of interest with a visual image representing the same scene/object/region of interest and being captured simultaneously as the IR image. As yet an example this might involve grouping a captured IR image representing scene/object/region of interest with an IR image representing the same scene/object/region of interest being captured at a previous occasion. This might prove useful when repeatedly monitoring scene/object/region of interest, e.g. when periodically monitoring machinery or electrical installations.

An advantage with the embodiment is that by presenting or visualizing a data item, such as an IR image, and related data items, such as application data items, as a group of data items in a data item container representation, the spatial and relative context is conveyed to the user of the IR camera. In addition by associating data items as a group of data items and enabling or performing operations on the container representation representing the group of data items, a more efficient handling of spatially and relatively related data items is achieved.

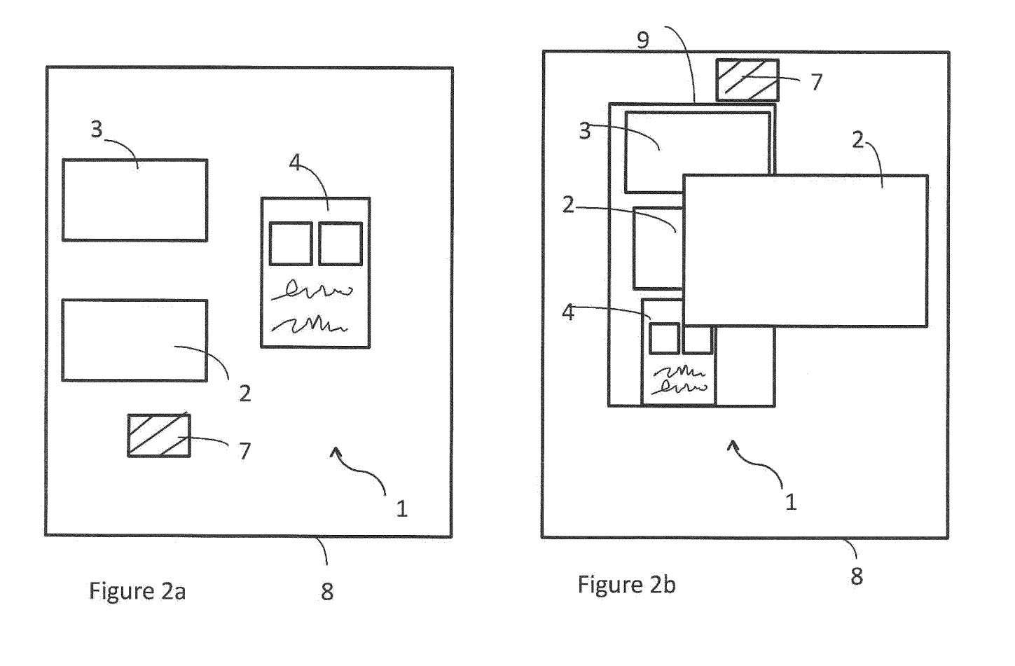

Furthermore, by using animations to visualize the transitions between different parts or data items of the group of data items the users are able to maintain a better understanding of spatially and relatively related data , or in simple terms what they are looking at, as shown for example in FIGS. 2-4.

FIG. 2 shows a visualized view of animations visualizing transitions between different parts or data items of group of data items, for example an IR image 2, text data 4, a digital visual image 3. Further, FIG. 2a-b shows a display 8 and a vertical list 9 comprising thumbnails of different types of group data items. FIG. 2b illustrates an example of an initial visual view that the user has of the system is that of a vertical list of the representation of different data items placed on the left next to it. This list contains representations of data items in the form of thumbnails of the elements or data items contained in the group of data items (an IR image 2, text data 4, digital visual image 3) together with a data item container representation of the group of data items in the form of a group icon 7. The group icon 7 is in FIG. 2a-b, illustrated by a dashed box and may be similar to a folder icon.

The data, or data items, can be operated on (e.g. browsed) one by one, and by clicking on their representation in the form of thumbnails, they are brought to the full view. According to embodiments, there is an animation sequence taking place each time an operation on the data item (e.g. navigation) is initiated.

In some embodiments, a processor may be adapted to control IR camera user interface functionality to present or visualize representations of data items in a data item container representation.

In some embodiments, the presentation or visualization of data items in a data item container representation may involve presenting data items in the group of data items in stacked levels or layers, wherein the stacked layers are rendered with different rendering depths, for example, a first layer as a front layer and a second layer as a back layer. In some embodiments, the stacked layers comprise a first layer and a second layer, wherein the first layer is rendered on top of the second layer. In some embodiments, the first layer superimposes, overlays, blends with or fuses with the second layer.

In some embodiments, the change of the presentation of a first data item in a first layer to presentation of a first data item in a second layer (e.g., from the back layer to the front layer) involves an animation of said change, wherein the animation comprises presenting a selection of intermediate and simultaneous presentations of the first and the second data items.

This animation may bring the element currently in the full view to the back layer and bring the element or data item to be shown in the full view to the front layer. According to an embodiment, the animation gradually alters the sizes of those elements or representation of data items, in other words the visually changing elements or representation of data items, from their initial state to the final.

When the user presses/selects/marks a group icon 7 for a group of data items, for instance using a cursor accessible via an input device, such as a mouse, a keyboard, buttons, a joystick, a tablet or the like coupled to the display device on which the user interface is presented, or by interacting with a touch or pressure sensitive display on which the user interface is presented using a finger or a stylus, an overview of all the components or data items of the group is presented, as shown for example in FIG. 2a.

FIG. 2b shows the view shown after the user initiates the process to perform an animation effect by navigating to a selected data item which enlarges the representation of selected data item, for example using one or more of the input devices presented above.

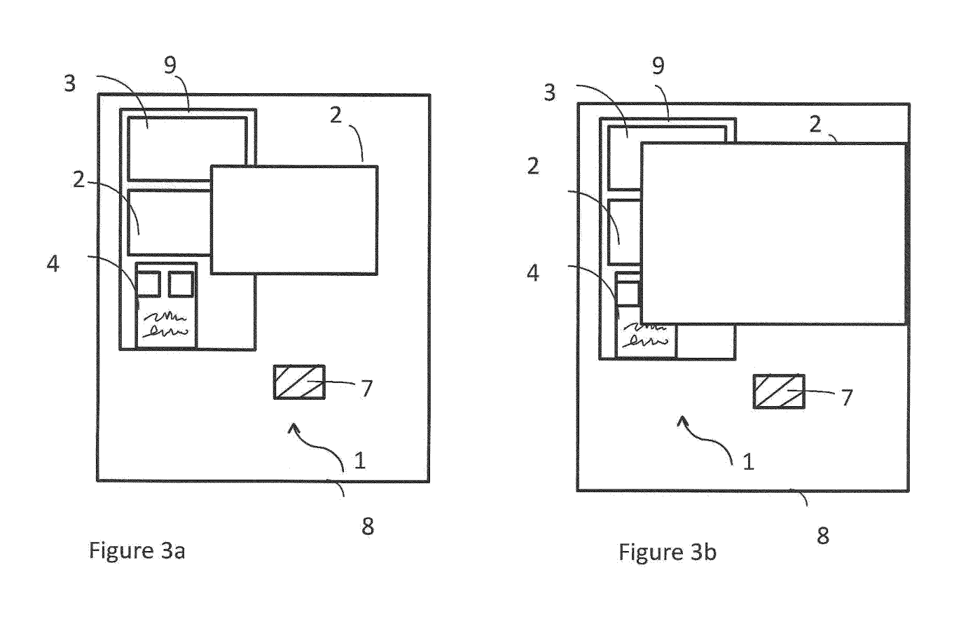

FIG. 3a-b shows another example of visualized view of animations according to an embodiment of the disclosure. Further, FIG. 3 shows a display 8, a vertical list 9 comprising thumbnails of different types of group data items, for example a digital visual image 3, an IR image 2, and a text data item 4. FIG. 3a-b show how the representation of the selected data item, an IR image 2, in FIG. 3a is enlarged in FIG. 3b after the user navigates to the IR image 2 in FIG. 3a. The enlargement or animation is for example performed when the user navigates to or selects a data item from the group of data items.

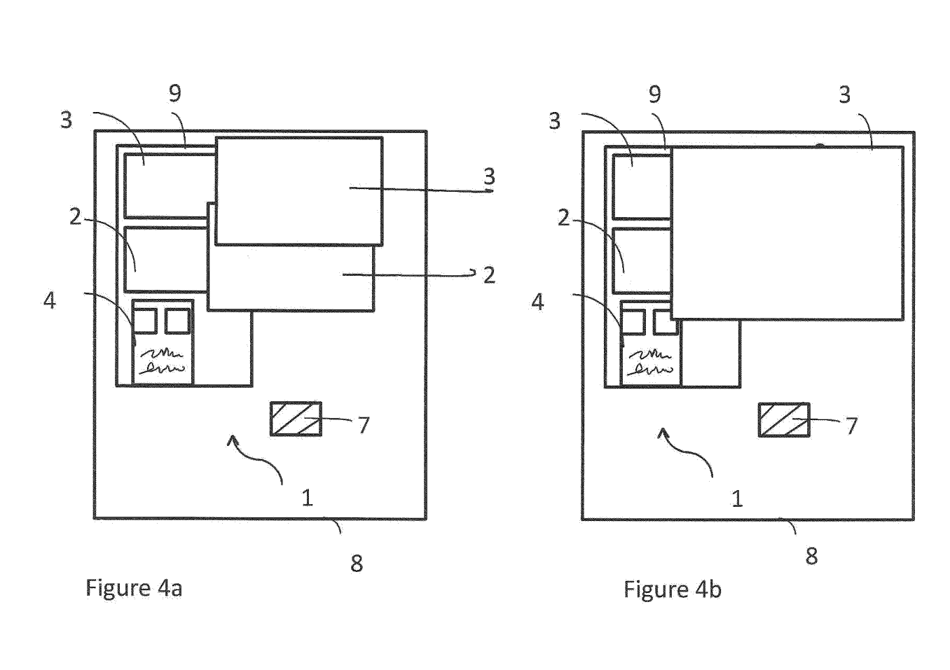

FIG. 4a-b shows another example of visualized view of animations according to an embodiment of the disclosure. Further, FIG. 4a-b show a display 8, a vertical list 9 comprising thumbnails of different types of group data, for example a digital visual image 3, an IR image 2 and a text data item 4. FIG. 4a shows a view which is shown when the user has selected one data item, an IR image 2, and then selects another data item, a digital visual image 3, from the list. An animation is then performed as can be seen in FIG. 4a wherein the new selected data item (digital visual image 3) is enlarged and at the same time the representation of the previously shown data item (IR image 2) is decreased. FIG. 4b shows the next step where only the most recently selected data item, in this case the visual image 3, is shown together with the vertical list 9 of thumbnails of the other data items in the group of data items.

An advantage with the embodiment is that by animating the change in view when presenting or visualizing a data item, such as an IR image, and related data items, such as application data items, as a group of data items in a data item container representation, an increased understanding of the relative spatial and relative context is conveyed to the user of the IR camera. Thus, a more efficient handling of spatially and relatively related data items is achieved.

As an example, when the user of the IR camera is comparing images of the same object obtained at regular intervals, the effort switching of the view of a first data item to a view of a second data item back and forth, which may be involved involved when making a relative comparison, is greatly reduced as the intuitive knowledge of where the, in the new view, previously selected data item is located, is improved.

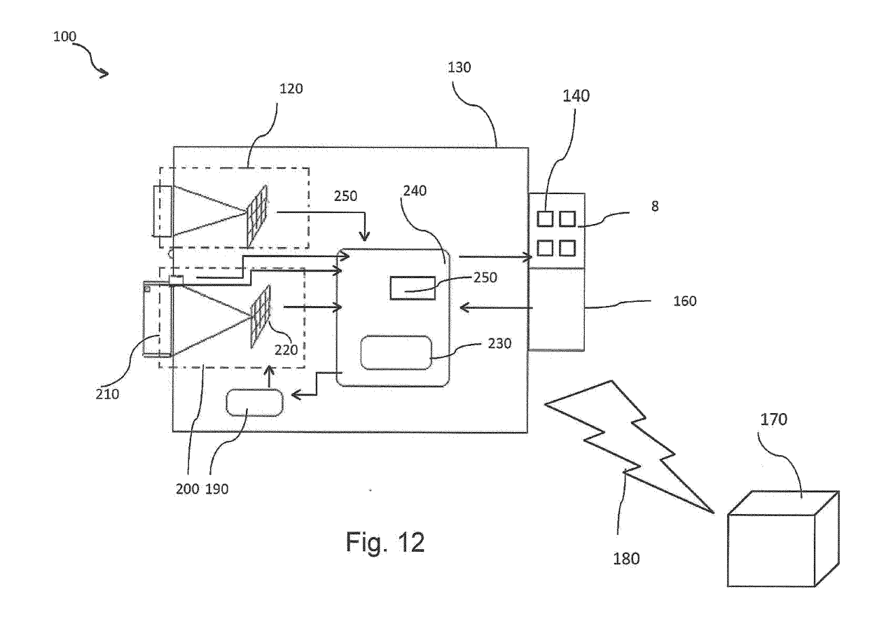

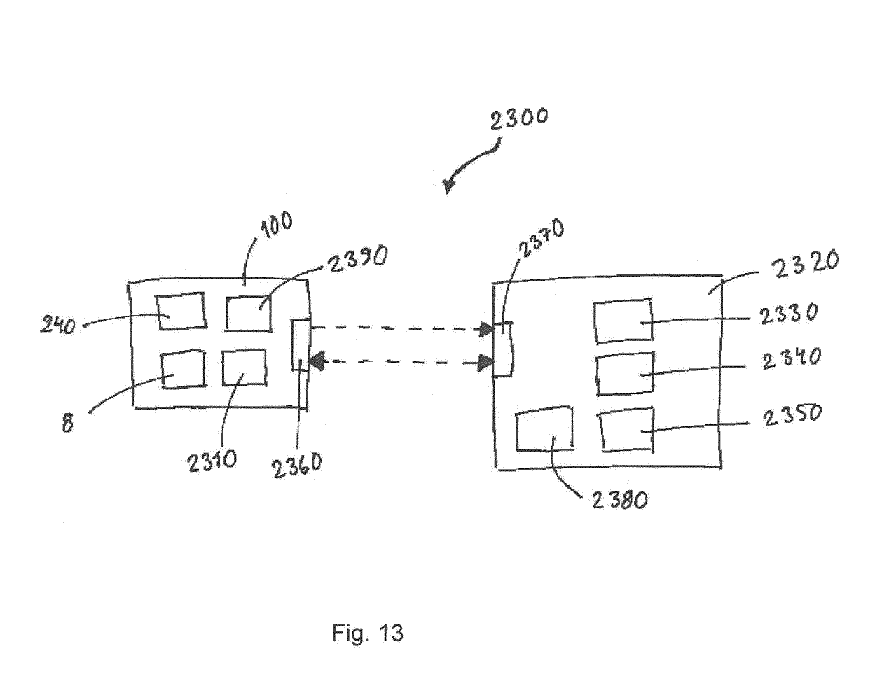

FIG. 12 shows a schematic view of an IR camera 100 in accordance with an embodiment of the disclosure. IR camera 100 comprises a housing 130, an IR objective 210, an imaging capturing device 220, an IR image focusing mechanism 200, a visual camera 120 and a processing unit 240. The processing unit 240 comprises, in one embodiment, an FPGA (Field-Programmable Gate Array) 230 for processing of the captured image and a general CPU 250 for controlling various functions in the camera, for example data management, image handling, data communication and user interface functions. The processing unit 240 is usually coupled to or comprises a volatile buffering memory, typically a RAM (Random Access Memory) adapted for temporarily storing data in the course of processing. The processing unit 240 is devised to process infrared image data captured by the image capturing device 220. According to an embodiment, software, firmware and/or hardware adapted to perform any of the method embodiments of the invention, e.g. by providing an IR image management and/or processing application adapted to be displayed on a display in an interactive graphical user interface and adapted to enable the method embodiments of the invention, is implemented in the processing unit 240. The processing unit 240 is further devised to transfer data from the IR camera 100 via wireless communication 180 to another unit, for example a computer 170, or another external unit, e.g. one of the units exemplified as workstation 2320 in connection with FIG. 13 below. The processing unit 240 is also responsible for, or in other words controls, receiving data from an input control unit 160. The input control unit 160 is coupled to input of the processing unit 240 and devised to receive and transmit input control data, for example commands or parameters data to the processing unit. According to an embodiment, the IR camera 100 further comprises a memory 2390 adapted to store groups of data items as a group of data items, e.g. image data and/or image-associated data, obtained by the different method steps for later viewing or for transfer to another processing unit, e.g. an embodiment of the workstation 2320, as presented below in connection with FIG. 13, for further analysis, management, processing and/or storage.

According to an embodiment, the managing of data items, such as IR image data, according to the method of the invention, is managed by the processors in the IR camera. According to an alternative embodiment, the managing of data items, such as IR image data, according to methods of the invention is managed by processors external to, or physically separated from, the IR camera. In other words, the managing of data items, such as IR image data, according to the method of the invention may be managed by processors integrated in or coupled to the IR camera. The coupling may be a communicative coupling, wherein the IR camera and the external processors communicate over a wired or wireless network. The coupling may also relate to the possibility of intermediate storing of data items, such as image data captured by the IR camera, and transfer of the stored data to the external processor by means of a portable memory device (not shown in figures).

Further the camera comprises a display 8 which shows virtual buttons or thumbnails 140. The virtual buttons or thumbnails 140, showing the different functions on the display 8 of the IR camera 100 may for example be animated and/or grouped as described below according to the method of the invention regarding managing IR image data.

According to embodiments shown in FIG. 13, a schematic view of a thermography system 2300 comprises a workstation 2320 (e.g. a personal computer, a laptop, a personal digital assistant (PDA), or any other suitable device) and an IR camera 100, corresponding to the IR camera 100 presented in further detail in connection with FIG. 12. The workstation 2320 comprises a display 2330 and a processor 2350 on which is implemented software, firmware and/or hardware adapted to perform any of the method embodiments of the invention, e.g. by providing data item, such as IR image, management and/or processing application adapted to be displayed on a display in an interactive graphical user interface and adapted to enable the method embodiments of the invention. According to some embodiments, the processor 2350 is adapted to perform any or all of the functions of processing unit 240, presented in connection with FIG. 12 above. According to an embodiment, the workstation 2320 comprises a memory 2380, adapted to store groups of data items as a group of data items, such as image data and/or image-associated data, obtained by the different method for later viewing.

The workstation 2320 may be connected to an IR camera 100 by a wired and/or wireless communications network and be enabled to perform one-way or two-way communication, as illustrated by the dashed arrows in FIG. 13. According to an embodiment, the communication between the IR camera 100 and the workstation 2320 is performed via communication interfaces 2360, 2370. According to an embodiment, a thermography software program, which is loaded in one or both of the IR camera 100 and workstation 2320, in conjunction with peripheral tools such as input devices/interaction functionality 2310, 2340 (e.g. buttons, soft buttons, touch functionality, mouse and/or key board etc. of camera 2310 and/or of workstation 2320) can be used to manipulate the display/presentation of the captured image data and other associated data visualized on the display 2340 of the workstation 2320, and/or on a display 2360 of the IR camera 2310, according to various methods disclosed herein.

Methods of the disclosure according to other embodiments will be described below. In one embodiment of the disclosure, a method of managing IR image may include:
a. Capturing an IR image comprising temperature data representing the temperature variance of an object scene;
b. Storing the IR image as a first data item in a predetermined data structure;
c. Storing a second data item in said predetermined data structure; and
d. Associating in said data structure the first and the second data item as a group of data items such that an operation is enabled on the first and the second associated data items jointly as a group of data items.

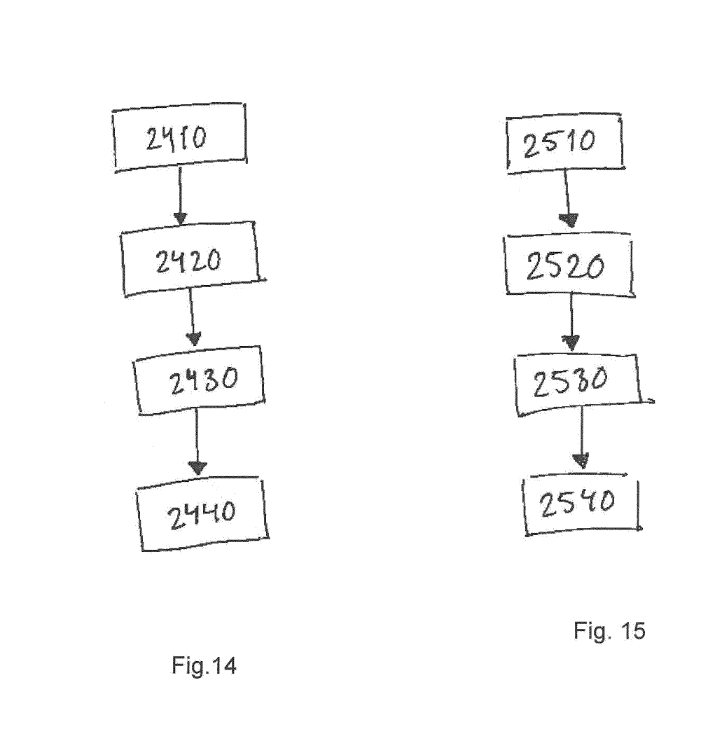

Various operations of this method may be performed in any order. This method embodiment is also illustrated in FIG. 14 as a block diagram, wherein:

Block 2410 comprises capturing an IR image comprising temperature data representing the temperature variance of an object scene;

Block 2420 comprises storing the IR image as a first data item in a predetermined data structure;

Block 2430 comprises storing a second data item in said predetermined data structure; and

Block 2440 comprises associating in said data structure the first and the second data item as a group of data items such that an operation is enabled on the first and the second associated data items jointly as a group of data items.

A second data item, which also is stored in the data structure according to various embodiments of the method, is for example a selection of: a visual image (digital camera photo); a user defined text annotation; a voice annotation; a sketch; a blended, superimposed, fused or in other way combined visual image and IR image; a filtered IR image; or other types of data which could be of interest for the user to be coupled to an IR image.

According to an embodiment, an operation is enabled on the first and the second associated data items, or any other two or more associated data items, jointly as a group of data items by, for example:
a. Associating the group of data items to a common descriptor parameter (e.g. a name);
b. Deleting the group of data items;
c. Copying the group of data items;
d. Adding the group of data items to a report;
e. Transmitting the group of data items to a recipient via a predetermined communications channel for example such as by email, wifi, Bluetoth or other communication channels; and
f. Presenting (displaying) the group of data items in an associated manner.

According to an embodiment, a method may also include the change between the presentation of a first and a second data item within a group of data items comprising an animation of the transition, presenting in the animation a selection of intermediate and simultaneous presentations of the first and the second data items, as shown for example in FIG. 2. This method embodiment is illustrated in FIG. 15 as a block diagram, wherein:

Block 2510 comprises receiving or retrieving a two and more associated data items as a group of data items;

Block 2520 comprises associating the group of data items to a common descriptor parameter e.g. a name;

Block 2530 comprises performing an action on the group of data items, the action e.g. being a selection of the following:
deleting the group of data items;
copying the group of data items;
adding the group of data items to a report; and
transmitting the group of data items to a recipient via a predetermined communications channel for example such as by email, Wifi, Bluetooth or other communication channels; and

Block 2540 comprises presenting/displaying the group of data items in an associated manner, on a display unit.

According to an embodiment, block 2540 further comprises presenting/displaying the change between the presentation of a first and a second data item within a group of data items, wherein presenting/displaying comprises an animation of the transition, wherein the animation comprises presenting a selection of intermediate and simultaneous presentations of the first and the second data items.

One specific but non-limiting example of the invention according to an embodiment is a very small specified group of data items that contains/comprises one IR image, a relative digital image, typically a corresponding visual image depicting the same scene as the IR image and being captured simultaneously as the IR image, and a form containing both the IR and digital images, typically a data representation in the form of a combined image comprising IR image data retrieved from the captured IR image and visible light image data from the captured visual image.

According to alternative embodiments, the combined image is obtained by superimposition/overlaying of image data, blending of image data or fusion of image data. The above mentioned form, also referred to as a text data item representation, is used by many kinds of users of IR cameras in order to create a written documentation of the problem detected. Such a detected problem may for example be a thermal anomaly. It usually includes the IR and digital data as well as information extracted from the IR and visual images, such as information regarding a detected problem or anomaly.

According to an embodiment, this grouped representation of data items, as a group of data items in a data item container representation, is used before the user finishes a specific sequence of interactions with the camera, usually sequence of interactions focusing on identifying a specific problem. According to an embodiment, the user is then brought to the grouped presentation state of the system, in order to be able to see if he has collected all the data he wanted and if the set of data to be saved is correct and adequate. This view may further be copied for further use, transmitted to a recipient, deleted or other action determined by the user. In other words, the view in which the user sees the grouped presentation of the associated data items may be copied, stored, transmitted to a recipient, deleted or managed according to any other action determined by the user.

In another example of an embodiment of the disclosure, a method for managing data items, such as thermal images/IR images and related application data items, may include:
a. Receiving, in a data processing unit, a (one or a plurality) thermal image or an IR image depicting (representing) a physical object (still image, motion image or mpeg4);
b. Receiving, in a data processing unit, an application data item (logically) related to the physical object represented by the thermal image or an IR image and a thermography application for the thermal imaging;
c. Associating the thermal image or an IR image with the application data item as a group of data items by assigning a common association indicium to the thermal image or an IR image and the application data item;
d. Storing the thermal image or an IR image and the application data item as a group of data items in a data structure such that the association is preserved between the thermal image or an IR image and the application data item;
e. Presenting or visualizing the thermal image or an IR image and the application data item as a group of data items in a data item container representation; and
f. Enabling or performing an operation on the container, for example the select, multiselect, draganddrop, copy, collapsible group, transmission of grouped items to other units, and also enabling numbering of the group or naming or algorithm naming of the group by the user.

### An Example Implementation of a UI

Presented below is an example implementation of a UI according to an embodiment. A simple relationship between source code (e.g., the C code for the UI) and the UI may be arranged in various embodiments, which gives a greater freedom regarding the design components used for this case and the animations included. The implementation is performed using a uiRoot control, followed by a frame and a page control, which includes a form control. In this form a series of other controls are included, such as five control controls, one dataform control and one list control. The dataform control then, includes four more controls.

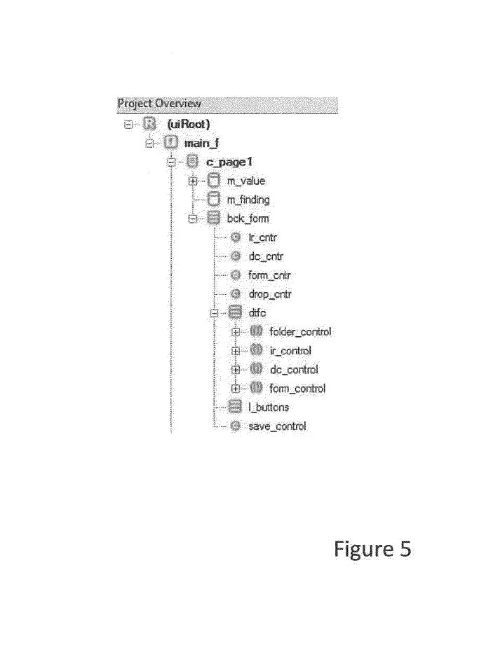

Generally, the idea behind this design is to have one independent control for each one of the components or data items of the group and one independent control for the group icon 7. On those controls different animation effects, such as described above or foreknown by the designer, can be applied. The list containing the representation of data items in the form of thumbnails of those components or data items, since it is stable in the sense that it always covers a specific part of space, is represented by a dataform control, also defining the group which is quite similar to a list and more flexible, and which encapsulates the thumbnail version of the group components or data items. Also the buttons such as save and exit may be implemented by a list control. The position of the components or data items can be pre-specified. The illusion of animation is created by alternating the size and position of the independent controls for each of the entities or data items of the group of data items (IR image, digital image, form) and by overlaying them to different rendering depths or stacked layers. The rendering depth can be a very useful feature of the implementation since it allows the user to follow one important component, as shown for example in FIGS. 1-5.

### Further Embodiments

According to an embodiment, the initial view that the user sees of the system is that of a data item, such as an IR image, in full view and a vertical list 9 of representations of different data items placed on the left next to it as a data item container representation. According to an embodiment, this list contains the representation of data items in the form of thumbnails of the elements or data items contained in the group of data items, together with a representation of the group of data items group icon 7, similar to a folder icon, placed above the thumbnails. Then, the data items can be browsed one by one and by clicking on their thumbnails, they are brought to the full view. There is an animation sequence taking place each time navigation is initiated.

In some embodiments, a processor may be adapted to control IR camera user interface functionality to present or visualize representations of data items in a data item container representation.

In some embodiments, the presentation or visualization of data items in a data item container representation may involve presenting data items in the group of data items in stacked levels or layers, wherein the stacked layers are rendered with different rendering depths, e.g. a first layer as a front layer and a second layer as a back layer. In some embodiments, the stacked layers comprise a first layer and a second layer, wherein the first layer is rendered on top of the second layer. In some embodiments, the first layer superimposes, overlays, blends with or fuses with the second layer.

In some embodiments, the change of the presentation of a first data item in a first layer to presentation of a first data item in a second layer, e.g. from the back layer to the front layer, involves animation of said change, wherein the animation comprises presenting a selection of intermediate and simultaneous presentations of the first and the second data items. This animation brings the element currently in the full view to the back layer, in other words to a rendering depth that is perceived as being further away from the viewer, and bringing the element to be shown in the full view to the front layer, in other words a rendering depth that is perceived as being closer to the viewer. The animation gradually alters the sizes of those elements or data items from their initial state to the final, as shown in FIGS. 2-4. Then the user can easily alternate from a view one form of data items to another data item and be able to identify details of interest to the data items acquired and saved.

According to an embodiment, the group icon, placed at the top of the thumbnails, is actually a button initiating a series of events as well. When the user presses it, an overview of all the components or data items of the group of data items is presented, with magnified versions of the elements or data items, while the vertical list with the representation of data items in the form of thumbnails is hidden. The user can go back to the previous state of the system, and make the vertical thumbnail list visible again, by pressing either the group icon again or any of the magnified versions of the icons representing data items.

According to an embodiment, this view of the system, i.e. the view presented above, was added to allow the user to compare the data items acquired and to propose a possible overview of different forms of data items. According to an embodiment, an animation sequence was used in this case also, so as to allow the user to follow the effects of the actions made.

According to embodiments, there may also be two more buttons placed under the thumbnails with labels Save and Exit wherein the Save button initializes an animation.

### Software Architecture

According to an embodiment, the software used for the implementation is an xml-based framework used internally by FLIR Systems, Inc. for the camera UI. The main concept behind this framework is the model-view-controller or model-visual-control (MVC) software architecture, which is used to differentiate between different roles and parts of applications. The term model is connected to data management and is responsible for, or in other words controls, the notification of the other application parts whenever a change is taking place in the data. The term view or visual is connected to the UI elements and the interactive part of the application. According to an embodiment, a view or a visual is represented by a UI component. According to an embodiment the UI component is visualized in the UI. The same model can have multiple views in the same application. Finally, the controller or control is the level that handles the events that arise from the interaction and alternates the models accordingly. It is also responsible for the initiation of feedback given in the view/visual level. From now on the terminology model-visual-control will be used for the description of those components.

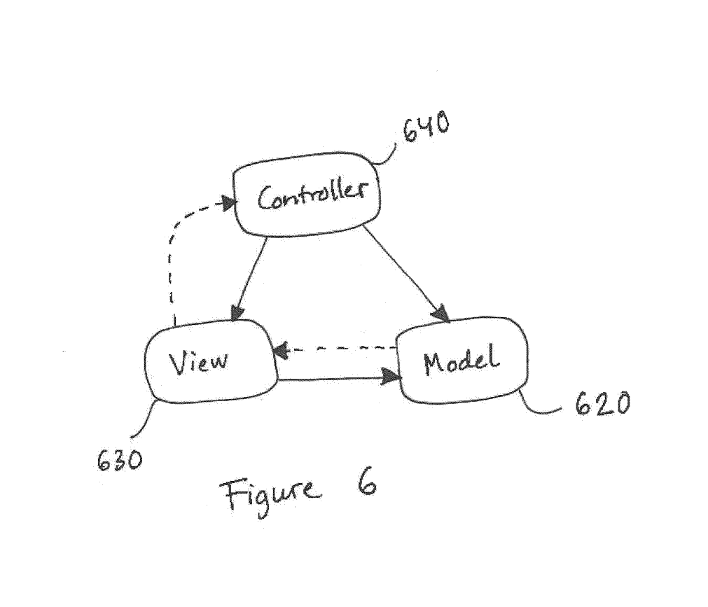

A schematic view of a MVC software architecture according to an embodiment, and the associations between the model, view and controller levels, is shown in FIG. 6, wherein a solid arrow represents a direct association, while a dashed arrow represents an indirect association, for example via an observer.

According to an embodiment, to the inventive embodiments are implemented in a common type processing device, such as a laptop computer. According to a further embodiment, the processing device includes touch based interaction. According to an embodiment, events are triggered by the user interacting with buttons, soft buttons, a touch or pressure sensitive screen, a joystick or another input device integrated in or coupled to the IR camera. Events triggered by the user interaction may for instance be to zoom in/out, save, etc. According to an alternative embodiment, events are triggered by the user interacting with a keyboard, a mouse or another input device in connection with a processing device external from the IR camera.

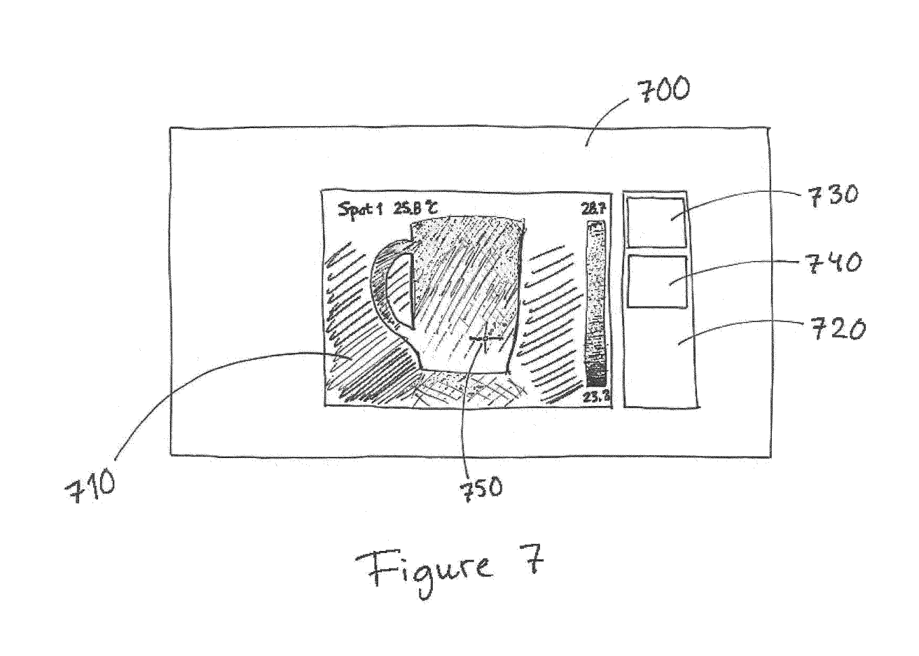

According to an embodiment shown in FIG. 7, the main application window 700 is exemplified as 660×340 pixels and in there two other components 710, 720 are drawn. The camera window 710, representing the camera screen, is the one where the live IR image acquired from the camera is shown and its resolution is exemplified as 320×240 pixels. The menu component 720 is the one placed on the right of the camera window 710 and it contains buttons 730, 740 representing physical buttons on the camera according to an embodiment. The quantity and the context of those buttons may vary according to different embodiments. In FIG. 7, a marker, or spot, 760 in the form of a hairs cross is shown. The temperature corresponding to the spot marker 760 is displayed in camera window, in this example in the upper left corner.

### Model-Visual-Controls

According to different embodiments the model 620, the visual, also referred as view 630 or UI component, and the controls 640 of the system shown in FIG. 6 may vary, depending on circumstances. If there is a need for further functionality to be added according to an embodiment, more controls may be added.

Some basic controls are presented in detail below, as a base for the demonstration of the elements added further for each embodiment. To begin with, the basic controls, used to create the common window view presented above in FIG. 7, are going to be presented one by one, Those controls are six and more than one instance of them was used in some cases.

The basic controls are presented in a hierarchical order, starting from the most important in the implementation tree, going to the less important and more flexible controls.

### uiRoot Control

The UI Root control is the most basic control that should exist in every application and initiates the implementation tree. The root control is always the starting point and it must contain the visuals, also referred to views or UI components, for the top control contained by it, which is usually a frame/frame control.

### Frame Control

The frame control is usually the top control in an application. It allows for grouping of other controls but in the same time it has the role of a browser. Therefore, it has the ability to invoke navigation through history, e.g. next, previous, and through other controls.

### List Control

The list control is a substantially independent control with multiple functionalities, able to stand alone and/or inside other controls. It is usually used to visualize large data spaces that might be out of the screen. It also needs to be connected to its own model which makes it flexible and easily changeable according to the state of the program.

### Page Control

The page control is mostly a grouping control, representing different views of the same application. It is usually placed in a frame control which allows the application to navigate from page to page.

### Form Control

The form control is a very powerful control that can be used not only to group other controls but to navigate through them. It can keep information for the id of the control that is active any current moment and it is suitable when multiple functionalities should be added in different levels.

### Control Control

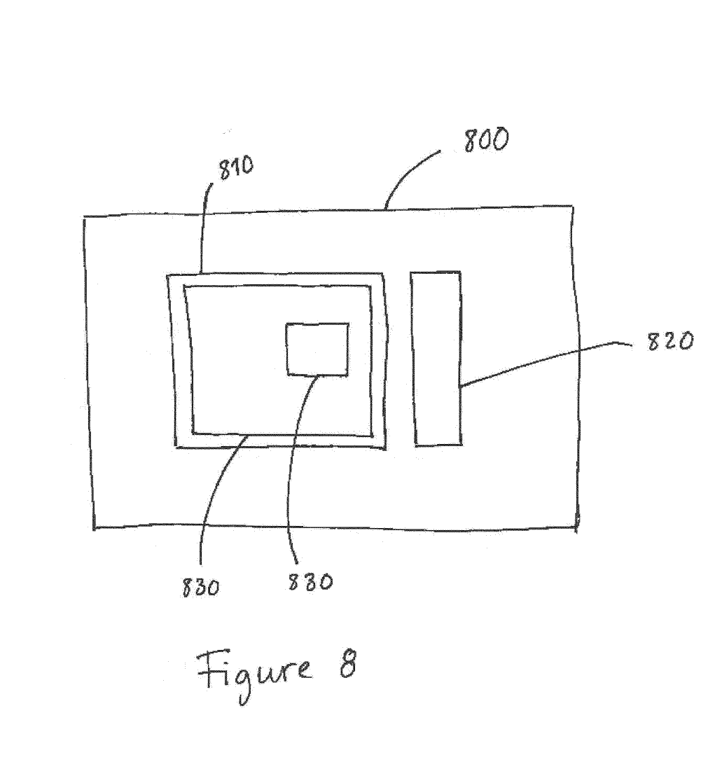

The control control is the most basic simple control. It cannot group other controls and it is always a bottom entity in the implementation tree. In FIG. 8, a schematic view of a selection of the controls used for realization of method embodiments is shown, comprising a frame control 800, a form and page control 810, a list control 820 and two control controls 830.

For each one of the controls a related visual was used as well. The visuals included in the software framework used, are different kind of entities, which, according to their form, bare different functionalities. The role of the visual components is, as explained before, to define the UI of the application. Therefore, they are useful to define margins, to draw specific schemas, to align elements etc. and to declare which of the parts of the UI that can produce events. Roughly, the visuals used can be categorized in two groups, the first group of visuals comprises those that are not visible to the user and their role is strictly organizational, while the second group of visuals comprises those that are visible to the user. Both of them, in other words visual belonging to either one of the groups of visuals, can identify the existence of events in most of the cases, if requested by the application. There is a third group of visuals equally important that has to do with the initiation of animation effects on the other visual components. Some of the visuals, also referred to as UI components, used for embodiments of the invention are described further herein below.

### Graphical Components

a) Image: Used to load images from a specific folder to the UI
b) Text: Used to produce specific text entries
c) Rect: User to draw rectangle areas

### Layouts

a) Container: Used to group other components or data items which are cropped at its borders.
b) Dock-Layout: Used as a container, but can also align the components in it.
c) ScrollBar: Represents a value interval graphically.

### 3 Scrollable Layouts

a) ListView: Used to visualize list controls and large data spaces that might need scrolling

### Animations

a) Action: Defines a group of actions that are initiated by a specific event
b) Animate: Defines a single component animation
c) setString: It is not really an animation but mostly an action to change the value of strings for different attributes.

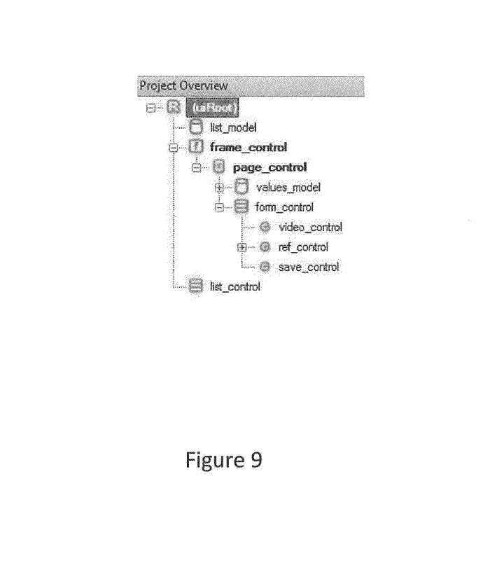

Together with the visuals and the controls there are also a number of models used in the implementation. The list model contains the buttons presented in the menu on the right of the camera view window and it is defined as a simple xml file. The values model is defined in the page control and contains a set of variables with information about the size of the different components of each prototype and boolean variables describing the state of the system. A simple organizational project tree containing the controls and model used can be seen in FIG. 9.

### Camera Video Stream

Another common component used in embodiments of the invention is the camera IR video stream that fetches a live video image from an IR camera into the laptop, or other workstation 170, 2320, application along with code for frame grabbing.

According to an embodiment, the code used and adapted for the embodiments of the invention is based in the DirectShow API, which is suitable for creating media streams on Microsoft® Windows® (DirectShow, 2010). According to an embodiments the code used could, or in other words is adapted to, identify the specific camera model and drivers, and create a suitable graph for the stream. The graph built contains a sequence of filters used to decompress the stream acquired (e.g. Sample Grabber, AVI decompressor, etc.). According to an embodiment, the frames grabbed from the stream are represented in the YUV colorspace and has to be transformed to simple ARGB format to be integrated in the code. For all the transformations made and the inner use of the frames grabbed, a common open source library was used, OpenCV (Open Source Computer Vision Library, 2010). Then the frames grabbed were provided to the integration layer of the C code to the UI, which was responsible for the rendering. The framework used could notify for the arrival of each new frame through a callback function, so as the UI scene to be rendered continuously. Since the IR video data contained a large amount of slightly compressed information, a firewire connection was used in order to achieve a good frame rate, around 20-25 fps.

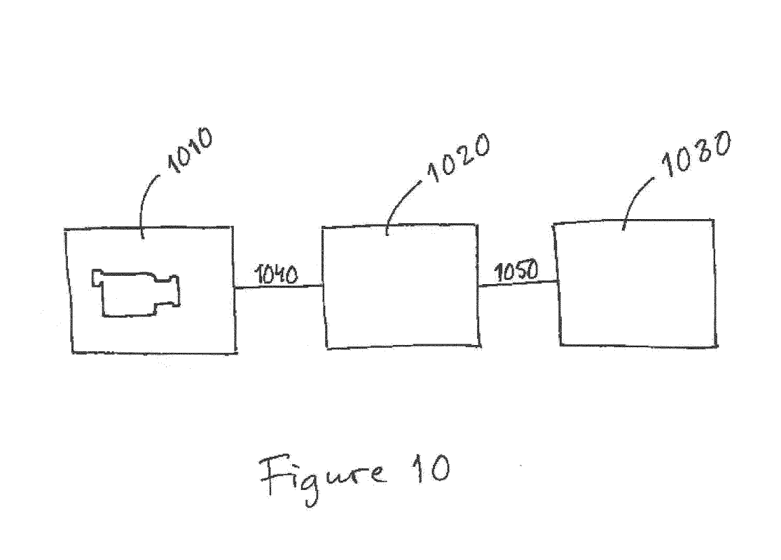

Having explained the common elements behind implementations according to various embodiments of the disclosure, each case can be viewed separately according to the problem posed. An system overview according to an embodiment is shown in FIG. 10, comprising an IR camera 1010, an integration level 1020 and a UI level 1030, wherein the connection 1040 between the IR camera 1010 and the integration level 1020 is an IR video stream, e.g. Directshow, and the connection 1050 between the integration level 1020 and the UI level is enabled by use of a library of programming functions, e.g. OpenCV.

According to embodiments, graphic effects, animation, direct manipulation and other interaction techniques are used in order to ease the identification and recreation of a specific scene of IR data given a reference image.

As explained above, for this case, the design proposed facilitates the user in multiple ways, e.g. by allowing the user to browse the IR space, by moving the camera and be able to identify some objects of interest. Having identified those objects the user may bring a similar image from the archive and compare it with the current situation. Embodiments of the disclosure allow for capturing images and permit the user to be in control of this procedure continuously.

### Functionality and Interactivity

Based on those goals, the embodiments of the disclosure will now be presented gradually below. According to an embodiment, the initial view that the user has is the camera view window, which contains the live IR video stream, and the menu next to it with a number of buttons (e.g., as shown in FIG. 7) wherein the menu comprises 2 buttons. According to an alternative embodiment, the menu comprises four different buttons; a) Freeze b) Image Archive c) Change View d) Save. When moving the IR camera, the user sees the video stream changing in the live IR camera space of the UI. According to an embodiment, the user is enabled to navigate through the IR space, identify different objects and focus on a specific scene.

According to an embodiment, the actions available in this state are either to freeze and then save, or bring up the image archive. When pressing the image archive button, a list with five thumbnails, or any other suitable number of thumbnails for instance based on predefined settings or selections performed by the user, appears on the upper part of the live IR view. The user could choose any of the five thumbnails available. From this point the user could either click in one of the thumbnails and bring it to an initial position, or grab a thumbnail and drop it to the live IR space.

According to an embodiment, as soon as the user brings the image to the live IR view, the archive list is hidden again. In case the user has brought a wrong thumbnail or just wanted to change the current one, he/she may either bring out the image archive again, by pressing the relevant button, and make the change, or double click on the current thumbnail and make it go back to the image archive. The image archive remains visible after that for the user to choose a new thumbnail. If the user does not want to choose a new thumbnail he/she could just hide the archive again.

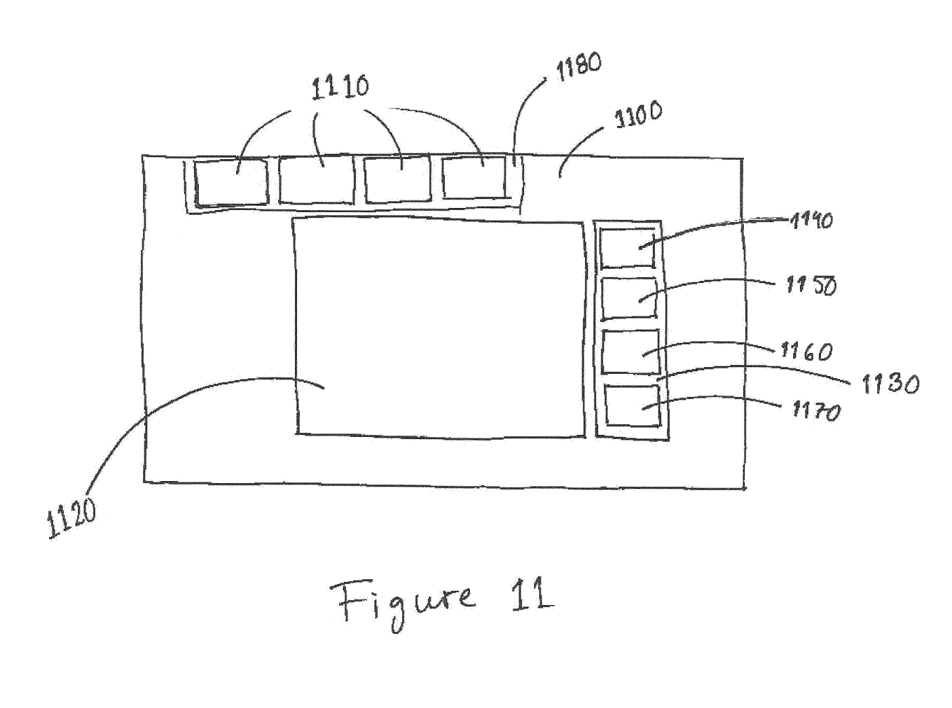

The view after pressing the archive button is shown in FIG. 11, in accordance with an embodiment of the disclosure. According to the embodiment shown in FIG. 11, there is a main application window 1100 comprising three other components 1120, 1130, 1180. The camera window 1120, representing the camera screen, is the one where the live IR image acquired from the camera is shown. An illustration of an exemplary live IR image, also referred to as an IR video stream, is shown in camera window 710 of FIG. 7. Menu component 1130 comprises, according to the illustrated example, four buttons 1140, 1150, 1160, 1170 corresponding for instance to the Freeze, Image Archive, Change View and Save buttons presented above. The quantity and the context of the buttons may vary according to different embodiments. According to an embodiment, component 1180 is a list with thumbnails, here illustrated as four thumbnails 1110, but any suitable number of thumbnails for instance based on predefined settings or selections performed by the user may be displayed in the list. The thumbnails 1110 represent images according to different views comprising visible light image data, IR image data and/or a combination of visible light data and IR image data. The user may click on/mark/select any of the thumbnails available in order to change the displayed view into the view represented by the selected thumbnail.

According to an embodiment the user may, having brought the wanted reference image from the archive, manipulate, in other words interact with, the UI, in other words the interactive components/items presented in the UI, in order to get it, the thumbnail view, to a preferable form. According to an embodiment, the user is enabled to directly manipulate the thumbnail which is shown in the live IR video view. According to different embodiments, the thumbnail view may be superimposed or overlaid onto the live IR video view. According to alternative embodiments, the image information of the thumbnail view may be blended or fused with the live IR video image. The user could either move the image, i.e. the thumbnail view that is shown in combination with the live IR video view, around, resize it, maximize it or minimize it. According to an embodiment, there is a maximum and a minimum size that the thumbnail, or view representation, can reach, so as to avoid hiding the whole live IR view or become so small that the user would not be able to manipulate it.

According to an embodiment, the user receives visual, audial or other relevant feedback when the user tries to move (e.g., selects and moves) a thumbnail, indicating which thumbnail view is selected, among more than one presented in the UI, and possibly providing different indications depending on which manipulation is performed on the thumbnail view. According to an embodiment, the user may apply as many actions as wanted until he/she reaches a satisfactory state.

According to embodiments, other views besides the one presented in FIG. 11 may be presented to the user. Therefore, according to an embodiment, the change view button in the menu could bring the user to a side-by-side view, where the reference image and the live IR view are placed the one next to the other, to ease the comparison. From this point, in other words according to this embodiment, the user may either click the reference image or the live IR space to enlarge them, in case their size is too small to identify specific details. According to an embodiment, each of the components in the side-by-side view, the live IR and the reference image, has two states. Their initial state is to have both the same size, and, according to an embodiment, if one of them is clicked it becomes bigger and the other one smaller. According to an embodiment, clicking the change view button again will directly bring the user to the initial state of the system, where the thumbnail is placed on the live IR space.

According to an embodiment, when the user has achieved a satisfactory result by manipulating the camera and with the help of the UI, he may freeze and save the view created. According to an embodiment, the view may be saved to a memory 2390 and/or 2380 of the thermography system of FIG. 13. The freezing operation allows the user to easily control the saving sequence and recover from possible errors. According to an embodiment, the user may freeze and unfreeze the view as many times as he wanted, without saving and if being unsatisfied from the result produced, he could just unfreeze and recreate the scene without having to produce a saved result. According to an embodiment, the user may also directly manipulate the reference image in the freezed/frozen state, in case it was affecting the view somehow. Freezing either in the normal view or in the side-by-side view would keep the state of the system as it is, but saving the image would initiate an informative message, return the system to the normal view, bring out the archive and place the reference image back to it, through a series of animation effects.

### Further Embodiments

Use of graphic effects, animation, direct manipulation and other interaction techniques, according to embodiments of the invention, ease the navigation and the user's perception of the zoomed in position in relation to the whole space.

As explained above, various embodiments of the disclosure may concern easing the perception of the user in the IR space, especially if being in a zoomed in state, when the data space is very limited and its relation to the environment is not clear. Therefore, according to embodiments, the user is further enabled to zoom in to specific details and navigate in the IR space effectively from one point to another. For example, when IR cameras are used in industry, there are many cases where the users have to focus on details placed far away from them and which are not approached easily. Then, because of this, the users need to able efficiently navigate in the IR space, while at the same time do not lose their understanding of the environment.

According to an embodiment, the user is enables to save instantly an image, without having to freeze first, since he/she might need to take several quick shots of the same problem, without loosing the view created and the focus on details. Except freezing and saving, the user may further be enabled to zoom in and out to specific details. According to an embodiment, when the user is freezing the image, except from being able to manipulate the overview window as before, he/she is also able to pan the freezed image in every direction. This feature is added in case the user has failed to lock the target in the image effectively, while in the zoomed in view. It is a known problem that small movements can alternate significantly the zoomed view of the camera. According to an embodiment, by adding the panning interaction, in the freezed, zoomed version of the image, an extra amount of data is presented and manipulated by the user, allowing him/her to target better the object of interest. Thus, if the user has been able to freeze an image somewhere near the object of interest, then he could, even after freezing, choose and create an optimal scene, targeting the problem identified, without having to repeat the procedure from the beginning. Then the user may save the result. According to an embodiment, panning may also be allowed even if not being on the freezed/frozen state.

According to an embodiment there is provided a computer system having a processor being adapted to perform any operations or functions of the embodiments presented above.

According to an embodiment of the invention, there is provided a computer-readable medium on which is stored non-transitory information for performing a method according to any of the embodiments presented above.

According to further embodiments, there is provided computer-readable mediums on which is stored non-transitory information for performing any of the method embodiments described above.

According to an embodiment, there is provided a computer program product comprising code portions adapted to control a processor to perform any operations or functions of any of the method embodiments described above.

According to an embodiment there is provided a computer program product comprising configuration data adapted to configure a field-programmable gate array (FPGA) to perform any operations or functions of any of the method embodiments described above.

According to an embodiment, the user can save groups of data items, such as image data and/or image-associated data, obtained by the different method steps to a memory 2380, 2390 for later viewing or for transfer to another processing unit 170, 2320 for further analysis, management, processing and/or storage.

In an alternative embodiment, disclosed methods can be implemented by a computing device 170, 2320 such as a PC that may encompass the functions of an FPGA-unit specially adapted for performing the steps of the method of the present invention, or encompass a general processing unit according to the descriptions in connection with FIGS. 12 and 13. The computing device may comprise a memory 2390 and/or a display unit 2330. Depending on circumstances it is possible to use the disclosed methods live, i.e. for grouping and managing a streamed set of images in real time, or near real time, for instance at 30 Hz, or to use still.

According to an embodiment, one or more groups of data items, such as image data and/or image associated data, are presented to the user of the IR camera 100 on a display 8, 2330 comprised in, or coupled to, the IR camera 100.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A method of managing data items on a group level in an IR-camera having a graphical user interface, the method comprising:
receiving a captured IR image as a first data item comprising temperature data representing the temperature variance of an object scene;
receiving an application data item as a second data item, related to the object scene represented by the IR image;
associating the first data item with the second data item as a group of data items such that an operation is enabled on the first data item and the second data item jointly as a group of data items;
storing the first data item and the second data item in a predetermined data structure such that the association as a group of data items is preserved between the IR image and the application data item;
presenting the first and the second data item as a group of data items in a data item container representation in said graphical user interface, wherein presenting the data item container representation comprises presenting a visual representation, such as thumbnail or an icon, of the first data item, the second data item and the group of data items; and
performing an operation on the container representation.

2. The method of claim 1, wherein the second data item is a selection of:
a. a visual image;
b. a user defined text annotation;
c. a voice annotation;
d. a sketch;
e. a blended, superimposed, fused or in other way combined visual image and IR image; or
f. a filtered IR image.

3. The method of claim 1, wherein the operation on said group of data items is a selection of:
a. associating the group of data items to a common descriptor parameter;
b. deleting the group of data items;
c. copying the group of data items;
d. adding the group of data items to a report; or
e. transmitting the group of data items to a recipient via a predetermined communications channel.

4. The method of claim 1, wherein the presentation or visualization of data items in a data item container representation comprises presenting data items in the group of data items in stacked layers, wherein the stacked layers are rendered with different rendering depths.

5. The method of claim 4, wherein the stacked layers comprise a first layer rendered on top of the second layer, wherein the change of the presentation of a first data item in a first layer to presentation of a first data item in a second layer comprises animations of said change.

6. The method of claim 5, wherein the first layer superimposes, overlays, blends with or fuses with the second layer

7. An IR camera having a graphical user interface comprising:
a housing;
an IR objective;
an IR imaging capturing device comprising an infrared (IR) imaging system adapted to receive incoming IR radiation from a scene and convert the IR radiation data into IR image data;
an IR image focusing mechanism;
a visual camera comprising a visible light imaging system adapted to receive incoming visible light radiation from a scene and convert the visible light radiation data into visible light image data;
a processor unit;
a display unit integrated in said IR camera, wherein the display is adapted to display an image comprising a selection of visible light data and/or IR image data and a user interface comprising user interface components; and
one or more input devices integrated in or coupled to the display,
wherein the processor unit is adapted to:
receive a captured IR image as a first data item comprising temperature data representing the temperature variance of an object scene,
receive an application data item as a second data item, related to the object scene represented by the IR image,
associate the first data item with the second data item as a group of data items such that an operation is enabled on the first data item and the second data item jointly as a group of data items,
store the first data item and the second data item in a predetermined data structure such that the association as a group of data items is preserved between the IR image and the application data item,
present the first and the second data item as a group of data items in a data item container representation in said graphical user interface, wherein presenting the data item container representation comprises presenting a visual representation, such as thumbnail or an icon, of the first data item, the second data item and the group of data items, and
perform an operation on the container representation.

8. The IR camera of claim 7, wherein the processor unit is configurable using a hardware description language (HDL).

9. The IR camera of claim 7, wherein the processor unit comprises a Field-programmable gate array (FPGA).

10. A non-transitory computer-readable medium on which is stored non-transitory information adapted to control a processor to perform the method of claim 1.

11. A computer program product comprising code portions adapted to control a processor to perform the method of claim 1.

12. The computer program product of claim 11, further comprising configuration data adapted to configure a Field-programmable gate array (FPGA) to perform the method of claim 1.
